(19) United States
(12) Patent Application Publication
(10) Pub. No.: US 2010/0060579 A1
(43) Pub. Date: Mar. 11, 2010

(54) Power Management Device for a Wireless Input Device and Related Wireless Input Device

(76) Inventor: Cheng-Su Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/204,804

(22) Filed: Sep. 5, 2008

(51) Int. Cl. G06F 3/033; G06F 3/02

(52) U.S. Cl. 345/163; 345/168

(57) ABSTRACT

A power management device for a wireless input device includes a sensor, built on a housing of the wireless input device, for sensing a distance between the housing and an object to generate a sensing result, and a control module, coupled to the sensor, for controlling an operating mode of the wireless input device based on the sensing result.

### BACKGROUND OF THE INVENTION

1. Field of the Invention

The present invention relates to a power management device of a wireless input device and the related wireless input device, and more particularly, to a power management device and the related wireless input device which can effectively advance user's convenience.

2. Description of the Prior Art

The role of a computer in our everyday life has evolved from a more traditional word processing, simple program operation tasks to today's much more comprehensive and complex functions, like audio/video processing and computer game entertaining. Devices for user's control interface, like keyboard and mouse, have also evolved gradually with the ever changing computer functions. Besides that, owing to the rapid development of the wireless communication technology, a wired mouse or keyboard which transmits data signals via physical medium of wiring has been replaced gradually by a wireless mouse or keyboard.

Please refer to FIG.1, which illustrates a schematic diagram of a wireless input device 10 according to the prior art. The wireless input device 10 is used in a computer system 100, and can be a wireless mouse, a wireless keyboard, etc. The wireless input device 10 comprises a data receiving module 102, a driving module 104, a wireless transmitting module 106 and a wireless receiving module 108. The data receiving module 102 is used for receiving user's control data, which can be a key enabling condition for a keyboard, and a moving event or a key enabling condition for a mouse. The wireless transmitting module 106 can transmit data received by the data receiving module 102 to the wireless receiving module 108 via wireless transmission, to control the operations of the computer system 100, and display corresponding effects of the moving action and the key enabling condition on the screen of the computer system 100. Besides that, the driving module 104 is utilized for supplying electrical power to the data receiving module 102 and the wireless transmitting module 106, to drive the normal functions of the data receiving module 102 and the wireless transmitting module 106.

Inside the wireless input device 10, the wireless transmitting module 106 transmits data to the wireless receiving module 108, via popular wireless transmission technology, like bluetooth, Infrared (IR), radio frequency (RF), etc. In other words, the wireless input device 10 is unable to get the required electrical power for operation via the computer system 100. Therefore, the driving module 104 must comprise an independent power source like a battery, or other devices which can store electrical power, in order to drive the data receiving module 102 and the wireless transmitting module 106. Under these conditions, for decreasing the inconvenience induced by the insufficiency of electrical power, the prior art proposed various methods for power management to decrease the consumption of electrical power and lengthen the time of usage. Among those methods, the most often seen power management method is when the user is not using the wireless input device 10, makes the wireless input device 10 to operate in a standby mode or a sleep mode. When the wireless input device 10 operates in the standby mode or the sleep mode, only minimum power is required to detect whether the user has come back to use the wireless input device 10. Once the detection shows that the user uses the wireless input device 10 again, the driving module 104 will restore to fully supply the required electrical power to the data receiving module 102 and the wireless transmitting module 106. However, it usually takes time for the process coming back from the standby mode or the sleep mode to the normal mode, which includes waking up various components or pairing between the wireless transmitting module 106 and the wireless receiving module 108. During this time, any operation by the user is considered as invalid. In other words, when the user has not used the wireless input device 10 for a period of time, the wireless input device 10 will enter a standby mode. When the user comes back to use the wireless input device 10 again, the user needs to wait for a period of time to return to the normal mode, and uses the wireless input device 10 again. This type of operation hinders the user from operating the computer system 100 in real time, and decreases user's convenience.

### SUMMARY OF THE INVENTION

Therefore, the primary objective of the present invention is to provide a power management device of a wireless input device and the related wireless input device.

The present invention discloses a power management device for a wireless input device comprises a sensor, built on a housing of the wireless input device, for sensing a distance between the housing and an object to generate a sensing result, and a control module, coupled to the sensor, for controlling an operating mode of the wireless input device based on the sensing result.

The present invention also discloses a wireless input device for enhancing utilization convenience comprises a housing, a data receiving module, built in the housing for receiving a control data, a wireless transmitting module, electrically connected to the data receiving module, for outputting wireless signals corresponding to the control data via wireless transmission, a radio-frequency (RF) receiving module, electrically connected to a computer system, for receiving the wireless signals output from the wireless transmitting module and transmitting to the computer system, a driving module, electrically connected to the data receiving module and the wireless transmitting module, for supplying electric power to the data receiving module and the wireless transmitting module, and a power management device comprises a sensor, built on the housing, for sensing a distance between the housing and an object to generate a sensing result, and a control module, coupled to the sensor and the driving module, for controlling operations of the driving module according to the sensing result, in order to control an operating mode of the wireless input device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a wireless input device according to the prior art.

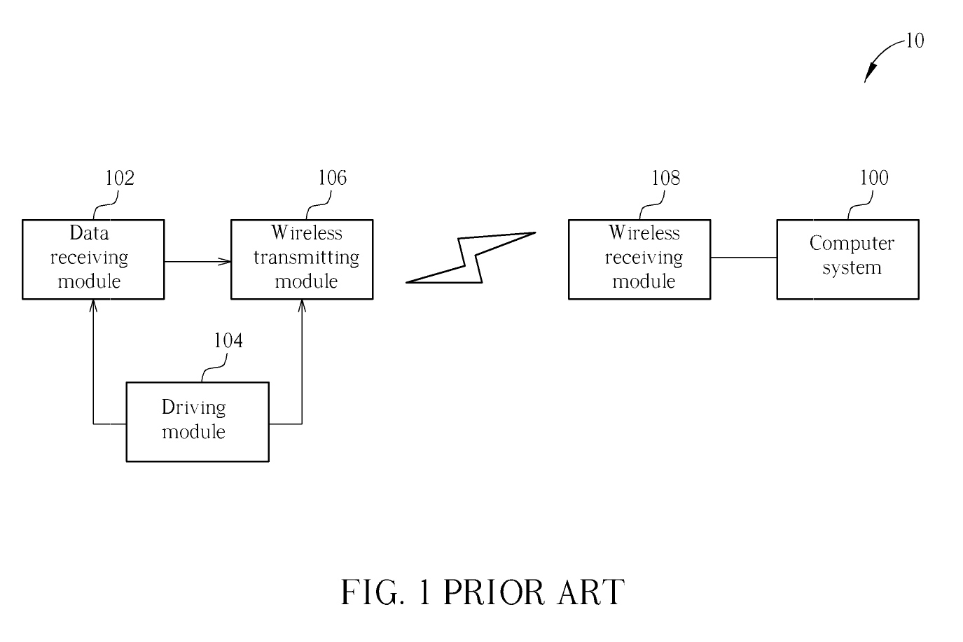

FIG. 2 illustrates a schematic diagram of a wireless input device according to an embodiment of the present invention.

FIG. 3 illustrates a schematic diagram of operations of the wireless input device shown in FIG. 2.

### DETAILED DESCRIPTION

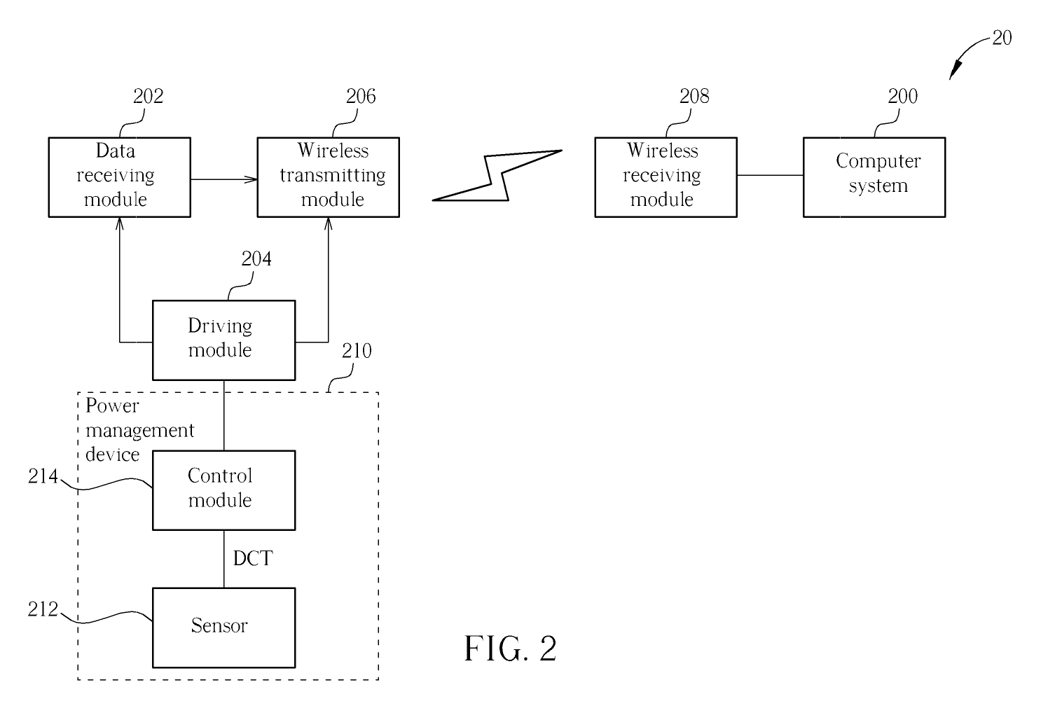

Please refer to FIG. 2, which illustrates a schematic diagram of a wireless input device 20 according to an embodiment of the present invention. The wireless input device 20 is utilized in a computer system 200, and can be a wireless mouse, a wireless keyboard, etc. The wireless input device 20 comprises a data receiving module 202, a driving module 204, a wireless transmitting module 206, a wireless receiving module 208 and a power management device 210. The data receiving module 202, the driving module 204, the wireless transmitting module 206 and the power management device 210 are built in a housing (not shown in FIG. 2) of the wireless input device 20, and the data receiving module 202 is electrically connected to the computer system 200. The operations of the data receiving module 202, the driving module 204, the wireless transmitting module 206 and the wireless receiving module 208 are similar to the operations of the data receiving module 102, the driving module 104, the wireless transmitting module 106 and the wireless receiving module 108, and will not be narrated hereinafter. Inside the wireless input device 20, the data receiving module 202 is utilized for receiving user's control data, which can be a key enabling condition for a keyboard, and a moving event or a key enabling condition for a mouse. The wireless transmitting module 206 can transmit data received by the data receiving module 202 to the wireless receiving module 208, via wireless transmission (like bluetooth, IR, RF, etc.) to control the operations of the computer system 200, and display corresponding effects of the moving action and the key enabling condition on the screen of the computer system 200. The driving module 204 is utilized for supplying electrical power to the data receiving module 202 and the wireless transmitting module 206, to drive the normal functions of the data receiving module 202 and the wireless transmitting module 206. Besides that, the power management device 210 comprises a sensor 212 and a control module 214. The sensor 212 is built upon the housing of the wireless input device 20, used for sensing the distance between the housing and an object to generate a sensing result DCT, in order to control the operations of the driving module 204, and the operating mode of the wireless input device 20.

Simply speaking, inside the power management device 210, the sensor 212 is utilized for detecting the distance between the user and the wireless input device 20, and the control module 214 is used for controlling the operation of the driving module 204 based on the sensing result DCT in order to control the operating mode of the wireless input device. For example, suppose the distance between the user and the wireless input device 20 is less than a predefined value, representing that the user may want to use the wireless input device 20, then the control module 214 can control the wireless input device 20 to operate in a normal mode. In other words, before the user uses the wireless input device 20, the control module 214 can make the wireless input device 20 to operate in the normal mode in advance. By doing so, the user needs not to wait for the wakeup time, and can immediately use the wireless input device 20.

As stated before, the wireless input device 20 can operate in the standby mode or sleep mode to decrease the inconvenience made by the insufficiency of electrical power while the user is not using. It usually takes some time for the process to go from the standby mode or the sleep mode to the normal mode, which includes waking up various components or pairing between the wireless transmitting module 206 and the wireless receiving module 208. Under these circumstances, the present invention can detect the distance between the user and the wireless input device 20, and control the operations of the driving module 204, such that the wireless input device 20 can operate in the normal mode, and the user needs no device wakeup time to wait, and can use the wireless input device 20 immediately.

Noteworthily, FIG. 2 illustrates a functional block diagram of the wireless input device 20. Those skilled in the art will readily observe that numerous modifications and alterations of the device and method may be made while retaining the teachings of the invention. For example, for saving power consumption, the sensor 212 is activated to detect the distance between the user and the wireless input device 20, only when the wireless input device 20 operates in the standby mode. The method of realization of the sensor 212 is not limited to any specific electronic device or component, and any electronic device or component which can detect the distance can be utilized in the wireless input device 20, like infrared sensor, light sensor, etc.

Inside the power management device 210, the control module 214 can make the wireless input device 20 operate in the normal mode based on the sensing result DCT of the sensor 212, such that the user needs no device wakeup time to wait, and can use the wireless input device 20 immediately. Besides that, if the distance between the user and the wireless input device 20 is greater than a predefined value, implying that the user is currently not using the wireless input device 20, then the control module 214 can also control the wireless input device 20 to operate in the standby mode to save electrical power.

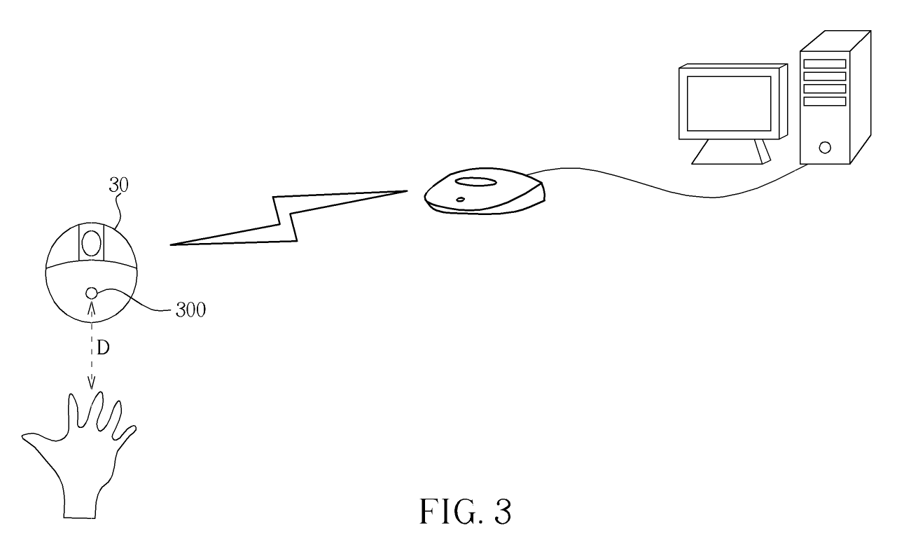

For clearly demonstrating the operations of the wireless input device 20, please refer to FIG. 3, which illustrates a schematic diagram of the operations of a wireless mouse 30. The wireless mouse 30 is realized according to the wireless input device 20. A sensor 300 is built on the housing and functions the same as the sensor 212, and is utilized for detecting a distance D between the user and the wireless mouse 30. When the user has not used the wireless mouse 30 for some time, the wireless mouse 30 will enter the standby mode. When the user comes back and likes to use the wireless mouse 30 again, once the distance D between the user and the wireless mouse 30 is less than a predefined value, the wireless mouse 30 will operate in the normal mode in advance according to the present invention, such that the user needs not to wait for a wakeup time, and can use the wireless mouse 30 right away.

To make a summary, the present invention can detect the distance between the user and the wireless input device, and control the operations of the driving module to make the wireless input device operate in the normal mode beforehand, such that the user needs no time to wait for a wakeup of the device, and can use the wireless input device immediately. Therefore, the user's convenience can be greatly advanced.

Those skilled in the art will readily observe that numerous modifications and alterations of the device and method may be made while retaining the teachings of the invention.

What is claimed is:

1. A power management device for a wireless input device comprising:
a sensor, built on a housing of the wireless input device, for sensing a distance between the housing and an object to generate a sensing result; and
a control module, coupled to the sensor, for controlling an operating mode of the wireless input device based on the sensing result.

2. The power management device of claim 1, wherein the sensor is an infrared sensor.

3. The power management device of claim 1, wherein the sensor is a light sensor.

4. The power management device of claim 1, wherein the sensor is utilized for starting to sense the distance between the housing and the object when the wireless input device operates in a standby mode, so as to generate the sensing result.

5. The power management device of claim 1, wherein the control module is utilized for controlling the wireless input device to operate in a normal mode when the sensing result indicates that the distance between the housing and the object is smaller than a predefined value.

6. The power management device of claim 1, wherein the control module is utilized for controlling the wireless input device to operate in a standby mode when the sensing result indicates that the distance between the housing and the object is greater than a predefined value.

7. The power management device of claim 1, wherein the wireless input device is a wireless mouse.

8. The power management device of claim 1, wherein the wireless input device is a wireless keyboard.

9. A wireless input device for enhancing utilization convenience comprising:
a housing;
a data receiving module, built in the housing for receiving a control data;
a wireless transmitting module, electrically connected to the data receiving module, for outputting wireless signals corresponding to the control data via wireless transmission;
a radio-frequency (RF) receiving module, electrically connected to a computer system, for receiving the wireless signals output from the wireless transmitting module and transmitting to the computer system;
a driving module, electrically connected to the data receiving module and the wireless transmitting module, for supplying electric power to the data receiving module and the wireless transmitting module; and
a power management device comprising:
a sensor, built on the housing, for sensing a distance between the housing and an object to generate a sensing result; and
a control module, coupled to the sensor and the driving module, for controlling operations of the driving module according to the sensing result, in order to control an operating mode of the wireless input device.

10. The wireless input device of claim 9, wherein the sensor is an infrared sensor.

11. The wireless input device of claim 9, wherein the sensor is a light sensor.

12. The wireless input device of claim 9, wherein the sensor is utilized for starting to sense the distance between the housing and the object when the wireless input device operates in a standby mode, so as to generate the sensing result.

13. The wireless input device of claim 9, wherein the control module is utilized for controlling the wireless input device to operate in a normal mode when the sensing result indicates that the distance between the housing and the object is less than a predefined value in order to control the operation of the driving module.

14. The wireless input device of claim 9, wherein the control module is utilized for controlling the wireless input device to operate in a standby mode when the sensing result indicates that the distance between the housing and the object is greater than a predefined value in order to control the operation of the driving module.

15. The wireless input device of claim 9, wherein the wireless input device is a wireless mouse.

16. The wireless input device of claim 9, wherein the wireless input device is a wireless keyboard.

17. The wireless input device of claim 9, wherein the wireless transmitting module outputs the wireless signals to the RF receiving module via a bluetooth technology.

18. The wireless input device of claim 9, wherein the wireless transmitting module outputs the wireless signals to the RF receiving module via an infrared transmission technology.

19. The wireless input device of claim 9, wherein the wireless transmitting module outputs the wireless signals to the RF receiving module via an RF transmission technology.
